(19) United States
(12) Patent Application Publication
(10) Pub. No.: US 2013/0077288 A1
(43) Pub. Date: Mar. 28, 2013

(54) LIGHT SOURCE APPARATUS

(71) Applicant: Shingo Yasuda, Hiratsuka-shi (JP)

(72) Inventor: Shingo Yasuda, Hiratsuka-shi (JP)

(73) Assignee: CANON KABUSHIKI KAISHA, Tokyo (JP)

(21) Appl. No.: 13/604,078

(22) Filed: Sep. 5, 2012

(30) Foreign Application Priority Data
Sep. 26, 2011 (JP) 2011-209575
Jul. 3, 2012 (JP) 2012-149451

(51) Int. Cl. F21V 7/05; F21V 9/10; G09F 13/14; F21V 9/08

(52) U.S. Cl. 362/97.2; 362/235; 362/230; 362/231

(57) ABSTRACT

A light source apparatus having a plurality of light-emitting members, according to the present invention, comprises: a light source substrate provided with a plurality of light source groups each of which is configured by first to fourth light-emitting members; and a reflective sheet disposed on the light source substrate and having a hole exposing the light source group, wherein, on a surface parallel to the light source substrate, a circumscribed quadrangle of each of the first to fourth light-emitting members has a substantially rectangular shape, and a shorter side of one of two adjacent light-emitting members is positioned on substantially the same straight line as a longer side of the other one of the two adjacent light-emitting members.

### BACKGROUND OF THE INVENTION

1. Field of the Invention

The present invention relates to a light source apparatus.

2. Description of the Related Art

An example of a configuration of a conventional liquid crystal display apparatus 800 is described with reference to FIGS. 8A and 8B. FIG. 8A is an exploded perspective view of the conventional liquid crystal display apparatus. FIG. 8B is a diagram showing an enlargement of the section indicated by a reference numeral C shown in FIG. 8A. Specifically, FIG. 8B shows an arrangement of light-emitting members (light-emitting diodes (LEDs)) and a through-hole 802f of a reflective sheet 802e facilitating reflection and diffusion of light emitted from the LEDs.

The liquid crystal display apparatus 800 has a liquid crystal panel 801, a direct backlight unit 802 (light source apparatus) provided on the back of the liquid crystal panel 801, and a frame 803 that holds the liquid crystal panel 801 from its display screen side.

The backlight unit 802 is a box-shaped member that is roughly enclosed by a backlight case 802a that opens its part on the liquid crystal panel 801 side and an optical sheet group 802b with optical transmissivity, light diffusivity, or light harvesting characteristics. A light source substrate 802c with a plurality of LEDs is disposed in the inside of the backlight unit 802 (on a surface of the backlight case 802a that faces the optical sheet group 802b). Further, the reflective sheet 802e provided with the through-hole 802f is disposed on the light source substrate 802c (on the optical sheet group 802b side of the light source substrate 802c) such that the LEDs of the light source substrate 802c are exposed. Due to this configuration, the backlight unit 802 functions as a surface light source for emitting light of uniform brightness and chromaticity in a light-emitting surface (a surface provided with the optical sheet group 802b).

Japanese Patent Application Publication No. 2006-049098 discloses a reflective sheet with a hole that exposes a plurality of LEDs disposed on the same axis.

There is a LED of which a circumscribed quadrangle 903 on a surface perpendicular to a light emission direction (a surface parallel to a light-emitting surface of the light source apparatus, which is a surface parallel to the light source substrate 802) has a rectangular (substantially rectangular) shape. For example, as shown in FIG. 9, in an LED that has a light-emitting part 901 having a substantially square surface perpendicular to the light emission direction and electrodes 902 provided on either end in one direction perpendicular to the light emission direction (one direction parallel to the light-emitting surface of the light source apparatus, which is a direction parallel to the light source substrate 802), the circumscribed quadrangle 903 on the surface perpendicular to the light emission direction has a rectangular shape. In the example shown in FIG. 9, the circumscribed quadrangle 903 has a rectangular shape of which left side and right side are shorter sides and upper side and lower side are longer sides. When using such an LED, the through-hole 802f is generally provided so as to expose not only the light-emitting part of the LED but also the entire LED.

In the backlight unit 802, in order to enhance color reproducibility of light emitted by the backlight unit 802, a plurality of LEDs that emit light of different peak wavelengths, such as LEDs 806R, 806G, and 806B, are used in a single light source group 802d. In the example shown in FIG. 8B, the light source group 802d is configured by four LEDs: the LED 806R, two LEDs 806G (LED 806G-1, LED 806G-2), and LED 806B. Here, each of the LEDs 806R, 806G, and 806B is a LED of which circumscribed quadrangle on a surface parallel to the light-emitting surface of the light source apparatus (surface parallel to the light source substrate 802) has a rectangular shape. For simplification, in FIG. 8B, the LEDs (LEDs 806R, 806G, and 806B) are shown by rectangulars which are the shapes of the circumscribed quadrangles thereof. The LED 806R is an LED emitting red light, the LED 806G an LED emitting green light, and the LED 806B an LED emitting blue light.

Furthermore, in order to improve the uniformity of brightness or chromaticity in the light-emitting surface of light emitted by the backlight unit 802, the plurality of LEDs included in the single light source group 802d are disposed close to each other such that the distance therebetween (between light-emitting centers) is short.

In the example shown in FIG. 8B, the LEDs are disposed as follows on the surface parallel to the light-emitting surface of the light source apparatus.

The LED 806R is disposed such that one of the two shorter sides of the LED 806R faces a longer side of the LED 806G-1 and that the line connecting the light-emitting center of the LED 806R and the light-emitting center of the LED 806G-1 becomes parallel to the loner sides of the LED 806R.

The LED 806G-1 is disposed such that one of the two shorter sides of the LED 806G-1 faces a longer side of the LED 806B and that the line connecting the light-emitting center of the LED 806G-1 and the light-emitting center of the LED 806B becomes parallel to the loner sides of the LED 806G-1.

The LED 806B is disposed such that one of the two shorter sides of the LED 806B faces a longer side of the LED 806G-2 and that the line connecting the light-emitting center of the LED 806B and the light-emitting center of the LED 806G-2 becomes parallel to the loner sides of the LED 806B.

The LED 806G-2 is disposed such that one of the two shorter sides of the LED 806G-2 faces a longer side of the LED 806R and that the line connecting the light-emitting center of the LED 806G-2 and the light-emitting center of the LED 806R becomes parallel to the loner sides of the LED 806G-2.

The distance between the LEDs can be made short by disposing the four LEDs in this manner. In order to realize this arrangement, it is preferred that the through-hole 802f be provided, not in each LED, but in each light source group, in terms of producing the light source apparatus easily. Specifically, the through-hole 802f is provided so as to expose the entire LEDs included in the single light source group 802d (FIG. 8B).

In the example shown in FIG. 8B, the quadrangle formed by connecting the centers of the four LEDs has a square shape of which length of each sides is P2. The through-hole 802f on the reflective sheet has a substantially square shape of which length of each sides is L2.

### SUMMARY OF THE INVENTION

However, the above-described conventional method of arranging the light-emitting members (the method of arranging the LEDs shown in FIG. 8B) expands the through-hole, reducing the effective reflective area of the reflective sheet. Consequently, the light from each light-emitting member cannot be used efficiently.

The present invention provides a light source apparatus capable of efficiently using light emitted from each light-emitting member to enhance light emission brightness.

A light source apparatus having a plurality of light-emitting members, according to the present invention, comprises:

a light source substrate provided with a plurality of light source groups each of which is configured by first to fourth light-emitting members; and

a reflective sheet disposed on the light source substrate and having a hole exposing the light source group,

wherein, on a surface parallel to the light source substrate,

a circumscribed quadrangle of each of the first to fourth light-emitting members has a substantially rectangular shape, and

a shorter side of one of two adjacent light-emitting members is positioned on substantially the same straight line as a longer side of the other one of the two adjacent light-emitting members.

In other words, a light source apparatus having a plurality of light-emitting members, according to the present invention, comprises:

a light source substrate provided with a plurality of light source groups each of which is configured by first to fourth light-emitting members; and

a reflective sheet disposed on the light source substrate and having a hole exposing the light source group,

wherein, on a surface parallel to the light source substrate,

a circumscribed quadrangle of each of the first to fourth light-emitting members has a substantially rectangular shape,

a shorter side of one of two adjacent light-emitting members faces a longer side of the other one of the two adjacent light-emitting members, and

a shape of an outer circumference of each of the light source groups configured by the first to fourth light-emitting members is substantially a square.

The present invention can provide a light source apparatus capable of efficiently using light emitted from each light-emitting member to enhance light emission brightness.

Further features of the present invention will become apparent from the following description of exemplary embodiments with reference to the attached drawings.

### BRIEF DESCRIPTION OF THE DRAWINGS

FIG. 1A is a diagram showing examples of a light source group and a through-hole of a light source apparatus according to an embodiment;

FIG. 1B is a diagram showing examples of a light source group and a through-hole of a conventional light source apparatus;

FIG. 2 is a diagram showing an example of an effective area of a reflective sheet according to the present embodiment;

FIG. 3A is a diagram showing an example of an analytic model of the light source apparatus according to the present embodiment;

FIG. 3B is a diagram showing an example of an analytic model of the conventional light source apparatus;

FIG. 4A is a diagram showing an example of a brightness distribution of the light source apparatus according to the present embodiment;

FIG. 4B is a diagram showing an example of a brightness distribution of the conventional light source apparatus;

FIG. 5A is a diagram showing an example of a relative brightness distribution of the light source apparatus according to the present embodiment;

FIG. 5B is a diagram showing an example of a relative brightness distribution of the conventional light source apparatus;

FIG. 6A and FIG. 6B are diagrams showing examples of a chromaticity distribution of the light source apparatus according to the present embodiment, and FIG. 6C and FIG. 6D are diagrams showing examples of a chromaticity distribution of the conventional light source apparatus;

FIG. 7 is a diagram showing examples of the light source group and the through-hole of the light source apparatus according to the present embodiment;

FIG. 8A is an exploded perspective view of a conventional liquid crystal display apparatus;

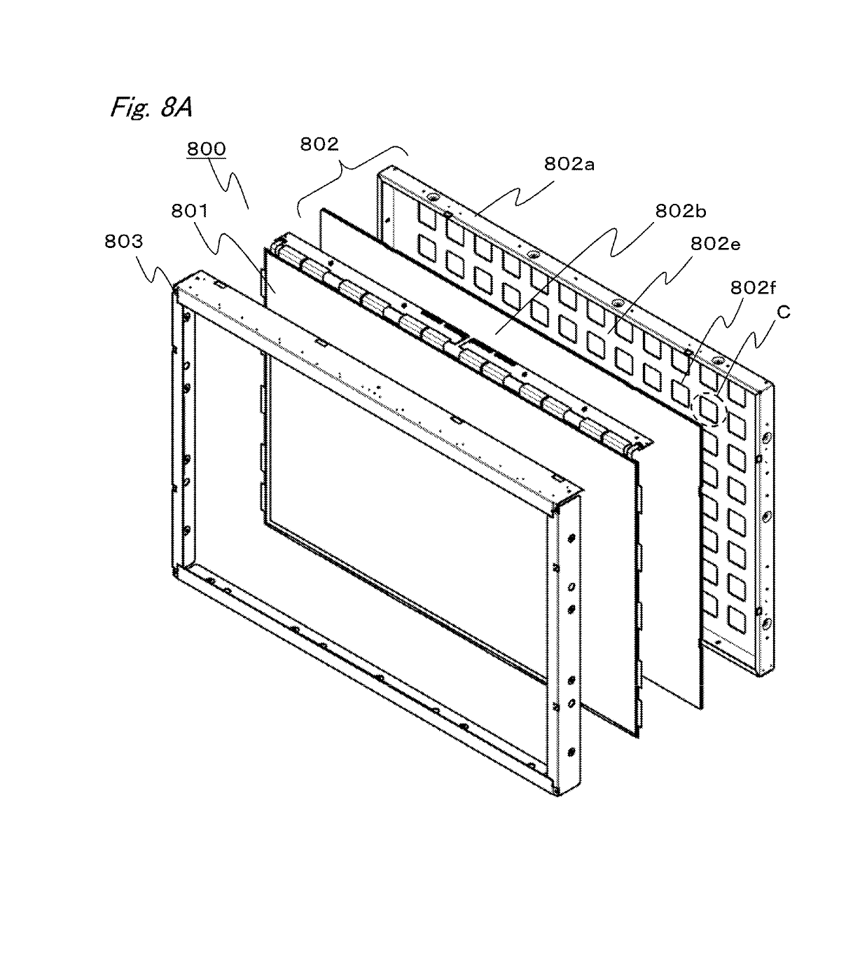

FIG. 8B is a diagram showing an enlargement of the section indicated by a reference numeral C shown in FIG. 8A;

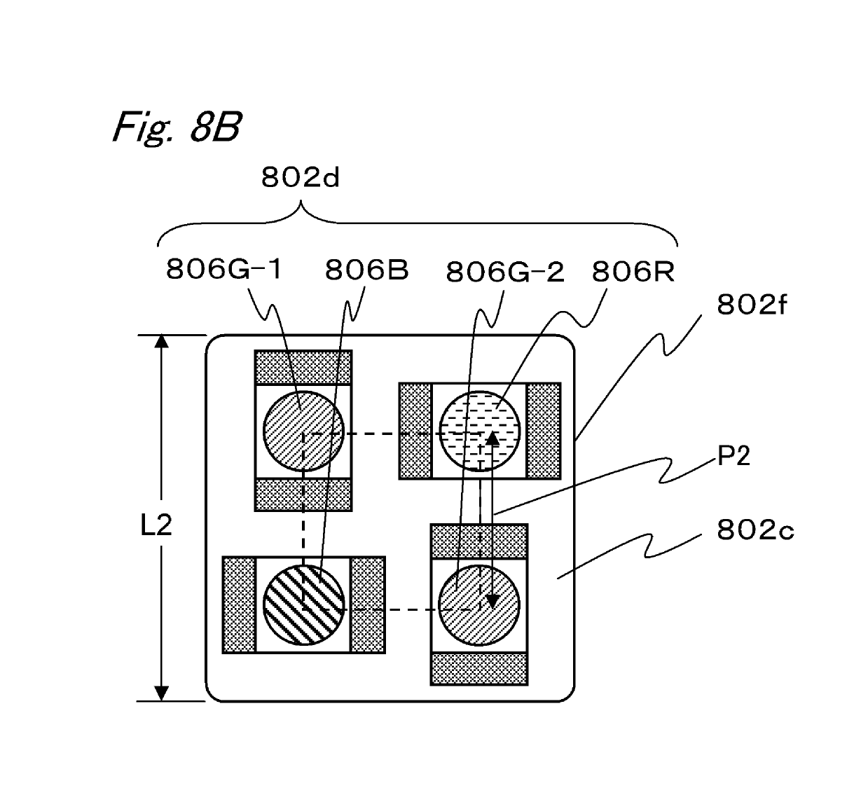

FIG. 9 is a diagram showing an example of a configuration of an LED; and

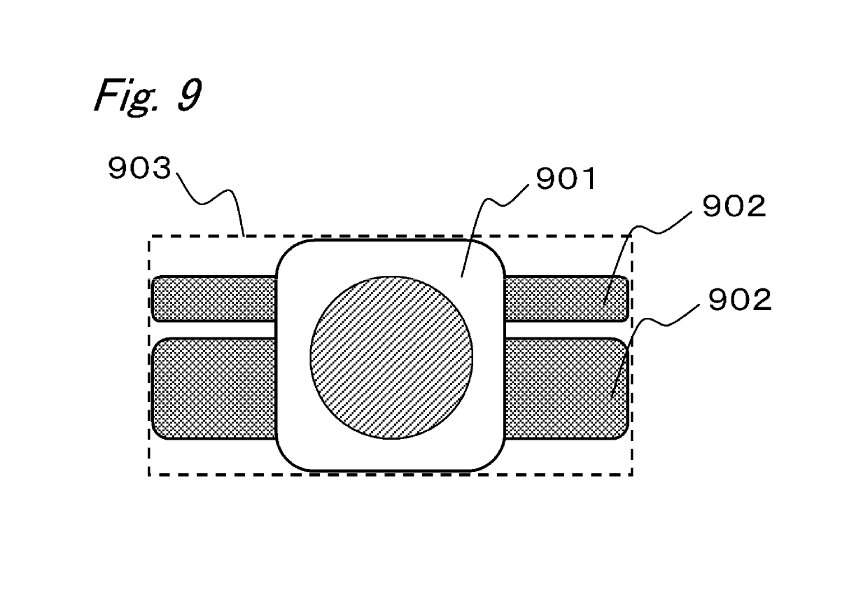

FIG. 10 is a diagram showing a modification of the light source apparatus of the present invention.

### DESCRIPTION OF THE EMBODIMENTS

Embodiments of the present invention are described hereinafter with reference to the accompanying diagrams. Note that the technical scope of the present invention is confirmed by the scope of patent claims and is not limited to the embodiments described hereinafter. All of the features described the embodiments are not necessarily essential to the present invention.

### Embodiment

A light source apparatus according to an embodiment of the present invention is described hereinafter.

The light source apparatus according to the present embodiment has a plurality of LEDs (Light-Emitting Diodes) as light-emitting members. Specifically, the light source apparatus according to the present embodiment has a light source substrate provided with a plurality of light source groups, and a reflective sheet that is disposed on the light source substrate and has holes (through-holes) exposing the light source groups.

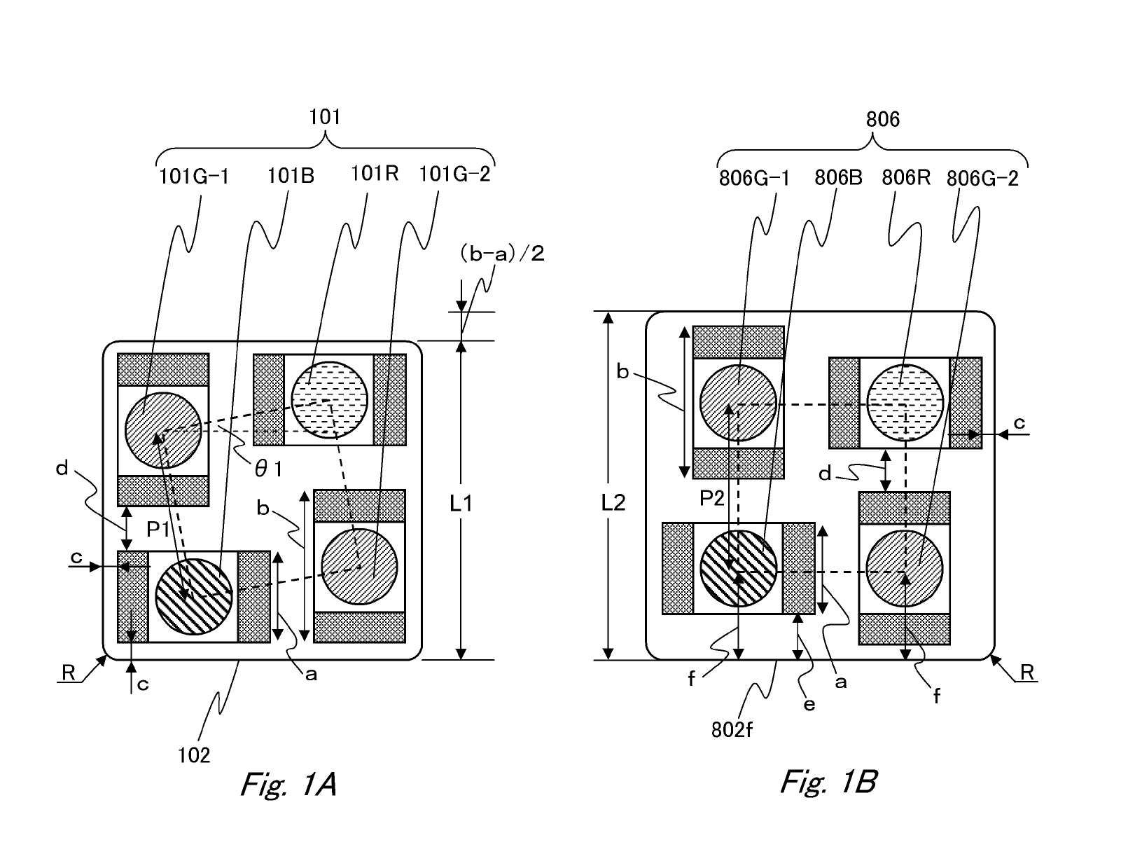

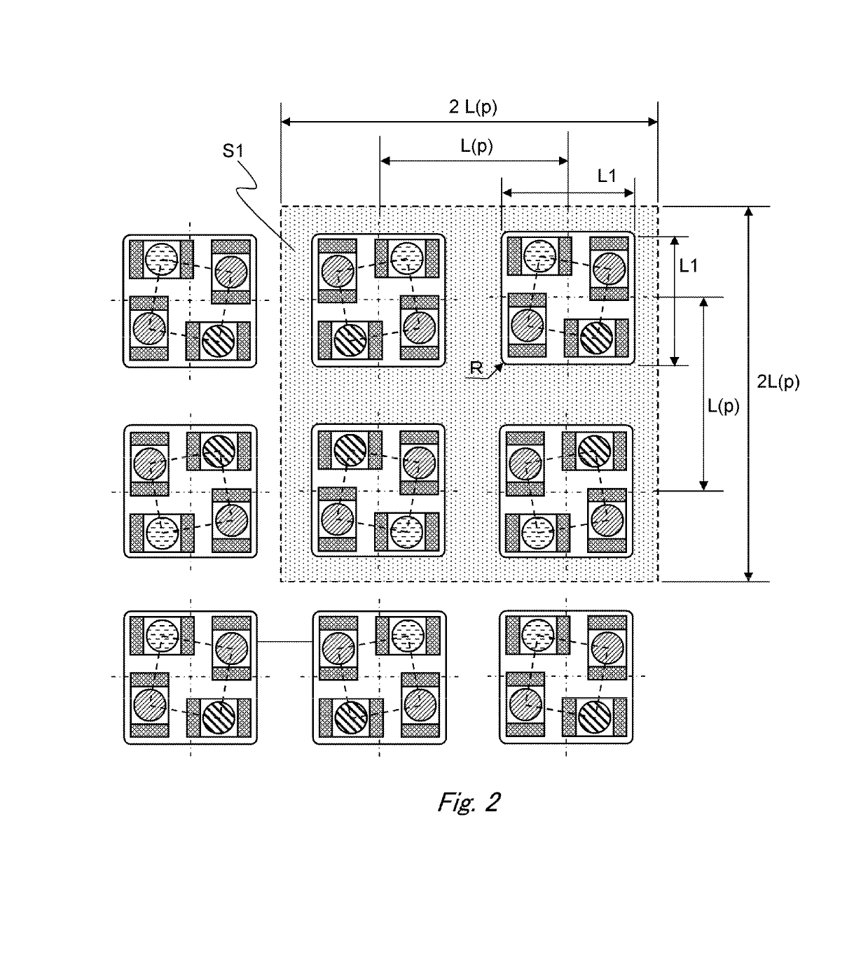

FIG. 1A is a diagram showing examples of each of the light source groups and each of the through-holes provided in the light source apparatus according to the present embodiment. FIG. 1B is a diagram showing examples of a light source group and a through-hole in a conventional light source apparatus. In FIGS. 1A and 1B, the light sources apparatuses are each viewed in a direction perpendicular to a light-emitting surface (direction perpendicular to the light source substrate).

In each of FIGS. 1A and 1B, an LED 101R (a first LED; a first light-emitting member) and LED 806R are red LEDs. An LED 101G-1 (a second LED; a second light-emitting member), LED 101G-2 (a fourth LED; a fourth light-emitting member), LED 806G-1, and LED 806G-2 are green LEDs. An LED 101B (a third LED; a third light-emitting member) and LED 806B are blue LEDs. Each of these LEDs is configured by a light-emitting part and two electrode parts provided on either end of the light-emitting part (either end being in one direction parallel to the light source substrate). Each of the LEDs is a LED of which a circumscribed quadrangle on a surface parallel to the light-emitting surface (a surface parallel to the light source substrate) of the light source apparatus has a rectangular (substantially rectangular) shape. For simplification, in each of FIGS. 1A and 1B, the LEDs are shown by the rectangulars which are the circumscribed quadrangles thereof. Although the present embodiment shows the light-emitting members as the LEDs, the light-emitting members may be any light-emitting members of which circumscribed quadrangles have rectangular shapes; thus, the present invention is applicable even when the light-emitting members are configured by organic EL light-emitting elements.

In the examples shown in FIGS. 1A and 1B, a single light source group is configured by four LEDs. Specifically, a light source group 101 is configured by the LED 101R, LED 101G-1, LED 101G-2, and LED 101B. Alight source group 806 is configured by the LED 806R, LED 806G-1, LED 806G-2, and LED 806B. A through-hole 102 of the reflective sheet exposes the light source group 101. The through-hole 802f exposes the light source group 806.

In the conventional configuration (FIG. 1B), the four LEDs of the single light source group are arranged as follows on the surface parallel to the light-emitting surface of the light source apparatus (the surface parallel to the light source substrate).

The LED 806R is disposed such that one of the two shorter sides (first shorter side) of the LED 806R faces a longer side (first longer side) of the LED 806G-1 and that the line connecting a light-emitting center of the LED 806R and a light-emitting center of the LED 806G-1 becomes parallel to the longer sides of the LED 806R.

The LED 806G-1 is disposed such that one of the two shorter sides (first shorter side) of the LED 806G-1 faces a longer side (first longer side) of the LED 806B and that the line connecting the light-emitting center of the LED 806G-1 and a light-emitting center of the LED 806B becomes parallel to the longer sides of the LED 806G-1.

The LED 806B is disposed such that one of the two shorter sides (first shorter side) of the LED 806B faces a longer side (first longer side) of the LED 806G-2 and that the line connecting the light-emitting center of the LED 806B and a light-emitting center of the LED 806G-2 becomes parallel to the longer sides of the LED 806B.

The LED 806G-2 is disposed such that one of the two shorter sides (first shorter side) of the LED 806G-2 faces a longer side (first longer side) of the LED 806R and that the line connecting the light-emitting center of the LED 806G-2 and the light-emitting center of the LED 806R becomes parallel to the longer sides of the LED 806G-2.

Hereinafter, the other shorter side of the two shorter sides of each LED that is not the first shorter side is referred to a “second shorter side”, and the other longer side of the two longer sides of each LED that is not the first longer side is referred to as “second longer side”.

In the configuration of the present embodiment (FIG. 1A), on the other hand, four LEDs of a single light source group are disposed such that one of the shorter sides of one LED of adjacent two LEDs is positioned on substantially the same straight line as one of the longer sides of the other LED of the adjacent two LEDs, on the surface parallel to the light-emitting surface of the light source apparatus (the surface parallel to the light source substrate). Specifically, the four LEDs of a single light source group are disposed as follows on the surface parallel to the light-emitting surface of the light source apparatus (the surface parallel to the light source substrate).

The LED 101R is disposed such that one of the two shorter sides (first shorter side) of the LED 101R faces a longer side (first longer side) of the LED 101G-1 and that the other shorter side (second shorter side) of the two shorter sides of the LED 101R is positioned on the same straight line (substantially the same straight line) as a longer side (second longer side) of the LED 101G-2.

The LED 101G-1 is disposed such that one of the two shorter sides (first shorter side) of the LED 101G-1 faces a longer side (first longer side) of the LED 101B and that the other shorter side (second shorter side) of the two shorter sides of the LED 101G-1 is positioned on the same straight line (substantially the same straight line) as a longer side (second longer side) of the LED 101R.

The LED 101B is disposed such that one of the two shorter sides (first shorter side) of the LED 101B faces a longer side (first longer side) of the LED 101G-2 and that the other shorter side (second shorter side) of the two shorter sides of the LED 101B is positioned on the same straight line (substantially the same straight line) as a longer side (second longer side) of the LED 101G-1.

The LED 101G-2 is disposed such that one of the two shorter side (first shorter side) of the LED 101G-2 faces a longer side (first longer side) of the LED 101R and that the other shorter side (second shorter side) of the two shorter sides of the LED 101G-2 is positioned on the same straight line (substantially the same straight line) as a longer side (second longer side) of the LED 101B.

In other words, on the surface parallel to the light-emitting surface of the light source apparatus (the surface parallel to the light source substrate), four LEDs are arranged such that a shape of an outer circumference of the light source group configured by these four LEDs is a substantially square.

In the examples shown in FIGS. 1A and 1B, a gap between the adjacent LEDs is constant on the surface parallel to the light-emitting surface of the light source apparatus.

For example, in the example shown in FIG. 1A, the gap between the LED 101R and the LED 101G-1, the gap between the LED 101G-1 and the LED 101B, the gap between the LED 101B and the LED 101G-2, the gap between the LED 101G-2 and the LED 101R are equal (substantially equal) to each other.

Therefore, in the examples shown in FIGS. 1A and 1B, a shape of a quadrangle formed by connecting the light-emitting centers of the LEDs is a square.

By disposing the LEDs as shown in FIG. 1A, the light source group can be exposed using a through-hole smaller than that of the conventional configuration (FIG. 1B).

The following explains this in greater detail.

In FIG. 1B, the shorter side and longer side of each LED are indicated as a and b, respectively. The gap between a rim of the through-hole 802f and the shorter side (second shorter side) of each LED is indicated as c, the gap between a rim of the through-hole 802f and the longer side (second longer side) of each LED as e, and the gap between the adjacent LEDs as d. A pitch between each rim of the through-hole 802f and the light-emitting center of each LED (the center of each light-emitting part) is indicated as f, and a pitch between the light-emitting centers of the adjacent LEDs as P2. The through-hole 802f has a square shape of which length of each sides is L2, and shapes of the four corners of the through-hole 802f are circular arc shapes of which a radius is R.

The size of each LED, the gap between the adjacent LEDs, and the shape of each of the four corners of the through-hole 102 in the example shown in FIG. 1A are the same as those of the example shown in FIG. 1B. However, in the example shown in FIG. 1A, the gap between a rim of the through-hole 102 and the shorter side (second shorter side) of each LED is equal to (substantially equal to) the gap between a rim of the through-hole 102 and the longer side (second longer side) of each LED (gap c). Unlike the arrangement of the LEDs shown in FIG. 1A, the gap between the rim of the through-hole and the shorter side of each LED cannot be made equal to the gap between the rim of the through-hole and the longer side of each LED in the arrangement of the LEDs shown in FIG. 1B.

Furthermore, a pitch between the light-emitting centers of the adjacent LEDs is indicated as P1, and the through-hole 102 has a square shape of which length of each sides is L1.

In addition, the square formed by connecting the light-emitting centers of the LEDs shown in FIG. 1A (the square of which length of each sides is P1) is inclined with respect to the square formed by connecting the light-emitting centers of the LEDs shown in FIG. 1B (the square of which length of each sides is P2), by θ1.

The following inequation is established based on the longer side b and the shorter side a.

b−a>0 (1)

In FIG. 1A, the following equation is established based on the longer side b, the shorter side a, the gap d between the adjacent LEDs, and the gap c between the rim of the through-hole 102 and the side (shorter side and longer side) of each LED.

L1=2c+(a+b+d) (2)

In FIG. 1B, the following equation is established based on the longer side b, the shorter side a, the gap d between the adjacent LEDs, the gap c between the rim of the through-hole 802f and the shorter side of each LED, and the gap e between the rim of the through-hole 802f and the longer side of each LED.

L2=c+e+(a+b+d) (3)

In FIG. 1B, the following equations are established based on the longer side b, the shorter side a, the gap d between the adjacent LEDs, the gap c between the rim of the through-hole 802f and the shorter side of each LED, and the gap e between the rim of the through-hole 802f and the longer side of each LED.

f=(a/2)+e (4)

f=(b/2)+c (5)

The following equation is obtained as a result of Equation (3)-Equation (2).

(L2−L1)=(e−c) (6)

The following equation is obtained from Equation (4)=Equation (5).

(e—c)=(b−a)/2 (7)

The following inequation is obtained from Equations (1), (6), and (7).

(L2−L1)={(b−a)/2}>0 (8)

It is clear from Inequation (8) that L2>L1, which means that the arrangement of the LEDs of the present embodiment (FIG. 1A) can made the through-hole of the reflective sheet smaller, compared to the arrangement of the LEDs of the conventional configuration (FIG. 1B).

For instance, suppose that a=3 (mm) and b=6 (mm). The length of the sides of the through-hole shown in FIG. 1A can be made shorter than the length of the sides of the through-hole shown in FIG. 1B by 1.5 (mm) based on Inequation (8). At this moment, L1=13.0 (mm) and L2=14.5 (mm) when c=1.0 (mm), d=2.0 (mm), and e=2.5 (mm).

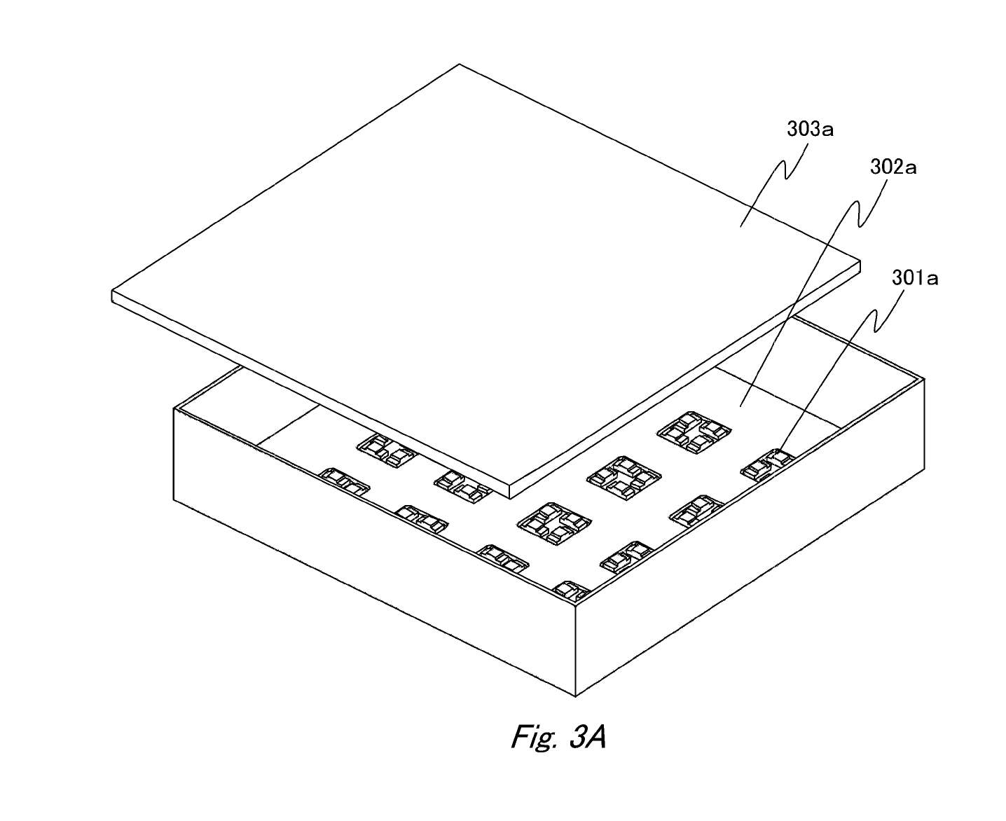

Next, effective areas of the reflective sheets are compared with each other using FIG. 2. Here, the radius R of the circular arcs at the four corners of each through-hole is set at 1.0 (mm), and a pitch L (p) between the adjacent light source groups is set at 25 (mm) (the interval L (p) is the distance between central positions of the light source groups). Hereinafter, the effective areas of the regions in the reflective sheets that correspond to the regions of four light source groups are compared with each other.

An effective area S1 of the reflective sheet of the light source apparatus according to the present embodiment is obtained by subtracting the areas of four through-holes on the reflective sheet from the area of a square of which length of each sides is 2L (p) as follows:

Affective area S1=50×50−{(13.0×13.0−(4−π))×4}≅1827 (mm²) (9).

Similarly, an effective area S2 (not shown) of the reflective sheet of the conventional light source apparatus is obtained as follows:

Affective area S2=50×50−{(14.5×14.5−(4−π))×4}≅1662 (mm²) (10).

The following equation can be obtained from Equations (9) and (10):

(S1/S2)=(1827/1662)≅1.099 (11).

In other words, it is clear that the arrangement of the LEDs of the present embodiment can obtain a larger effective area of the reflective sheet, compared to the arrangement of the LEDs of the conventional configuration, by approximately 9.9(%).

There has been implemented a technology in which a surface on a light source substrate on which LEDs are mounted (a mounting surface) is subjected to white resist printing to increase reflectivity and diffusivity of the LED and thereby reflectance of the mounting surface (reflectance that mainly contains a diffuse reflection component) is increased to approximately 70(%). On the other hand, the reflective sheet thereof is made of a foamable PET material or polypropylene laminate material and has a reflectance of approximately 98 to 99(%). This means that a reflective sheet with a small through-hole, which is a reflective sheet with a large effective area, is advantageous in terms of improving the brightness of the light source apparatus.

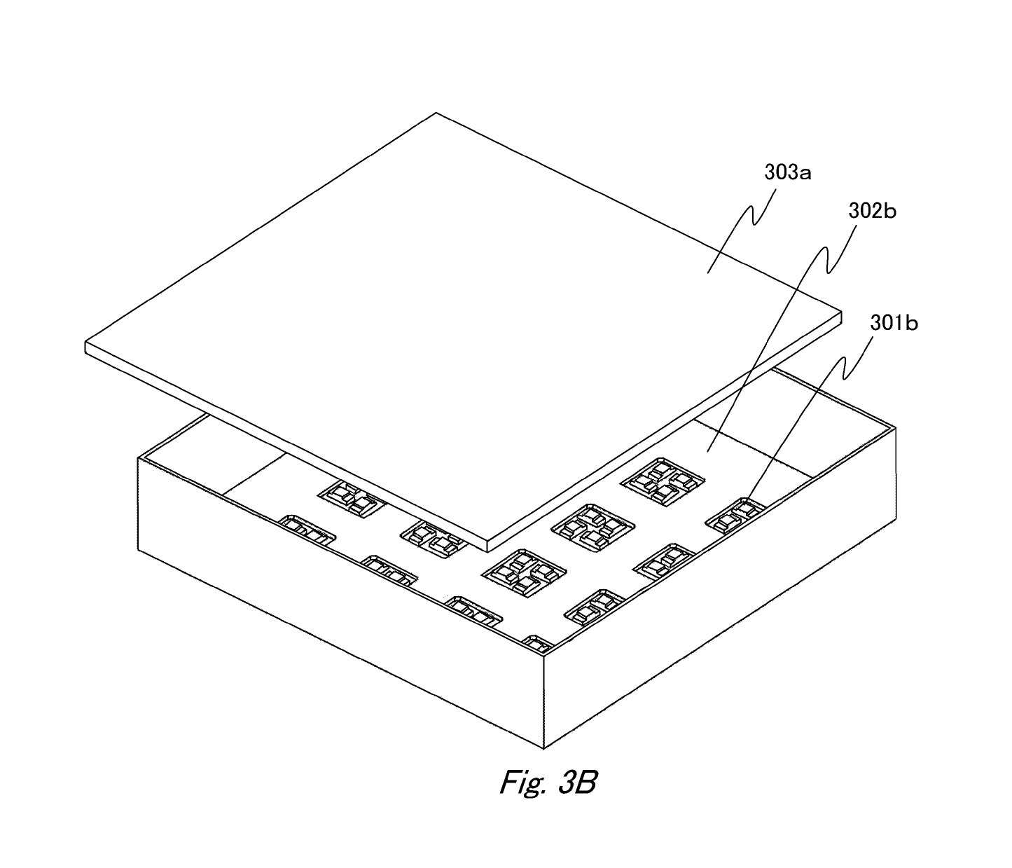

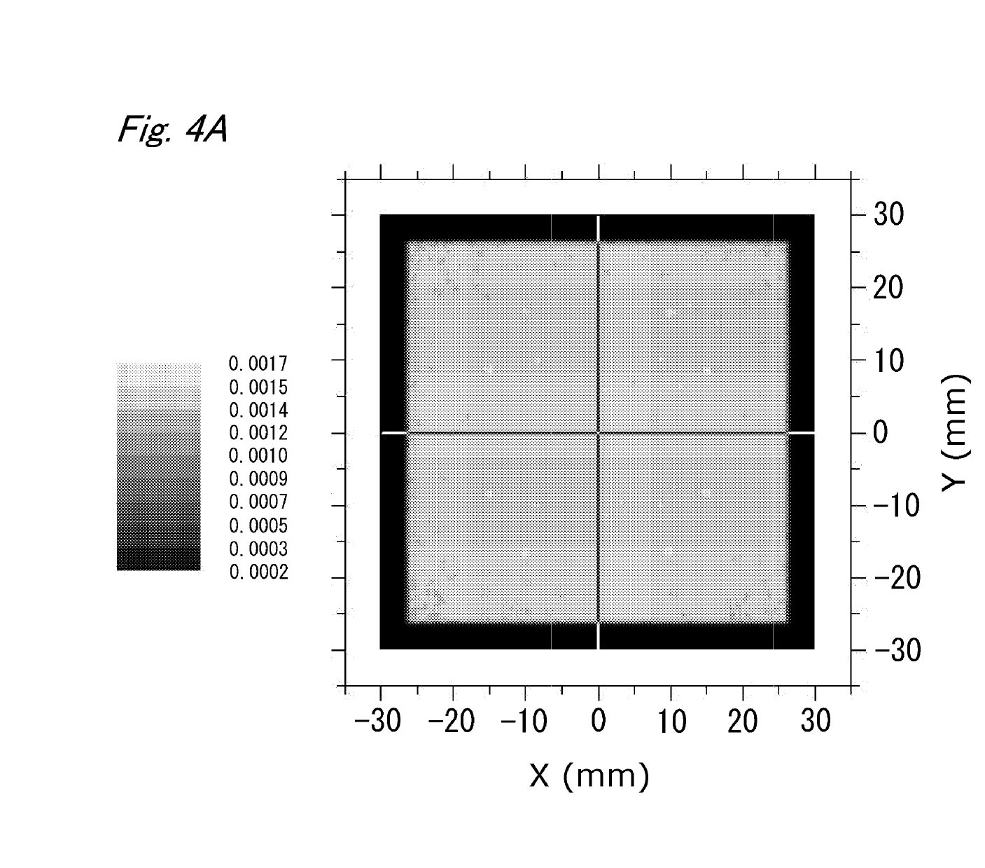

Impacts of increases in the effective areas of the reflective sheets on the brightness and chromaticity of the light source apparatuses are examined using FIGS. 3A to 6D. Optical simulation of simple analytic models were performed in order to examine the impacts.

FIG. 3A shows an analytic model of the light source apparatus according to the present embodiment. FIG. 3B shows an analytic model of the conventional light source apparatus.

The analytic model of the light source apparatus according to the present embodiment has a light source group 301a, a reflective sheet 302a, and a diffuser panel 303a. The light source group 301a is configured by four LEDs disposed in a manner as shown in FIG. 1A.

The analytic model of the conventional light source apparatus has a light source group 301b, a reflective sheet 302b, and the diffuser panel 303a same as that of the present embodiment. The light source group 301b is configured by four LEDs disposed in a manner as shown in FIG. 1B.

As shown in FIGS. 3A and 3B, the diffuser plates 303a are positioned away from case (cases for storing the light source substrates and the reflective sheets) so that the LEDs and the reflective sheets of the light source apparatuses can be observed. In actuality, however, the diffuser plates 303a are not away from the cases; thus the optical simulation is carried out with a sealed space where the diffuser plates 303a are in contact with the respective cases.

Conditions for the optical simulation are described hereinafter.

In the optical simulation, a single light source group is configured by a total of four LEDs: one red light source (R), one blue light source (B), and two green light sources (G). A total of sixteen light source groups (4 rows×4 columns) were arranged planarly, and the total of light rays from the LEDs was 150 million. The pitch between the light source groups was 25 (mm), and a spatial distance between reflective sheet and the diffuser plate was 25 (mm). A 60×60 (mm) planar region was provided, as an evaluation surface, in a position that is away from the surface of the 2-(mm)-thick diffuser plate by 3 (mm) in a light emission direction (a direction perpendicular to the light source substrate and extending to the side where light is output from the diffuser plate). The reflectance of the reflective sheet was 98(%), and Lambertian reflection, which is simple diffuser reflection, was set as a reflection condition. Here, the Lambertian reflection is reflection (scattering) where, when incident light that is emitted to a certain point, the brightness obtained at this point (incident point) is the same no matter what the angle of the observing point is.

The results of examining the brightness in the optical simulation are described hereinafter.

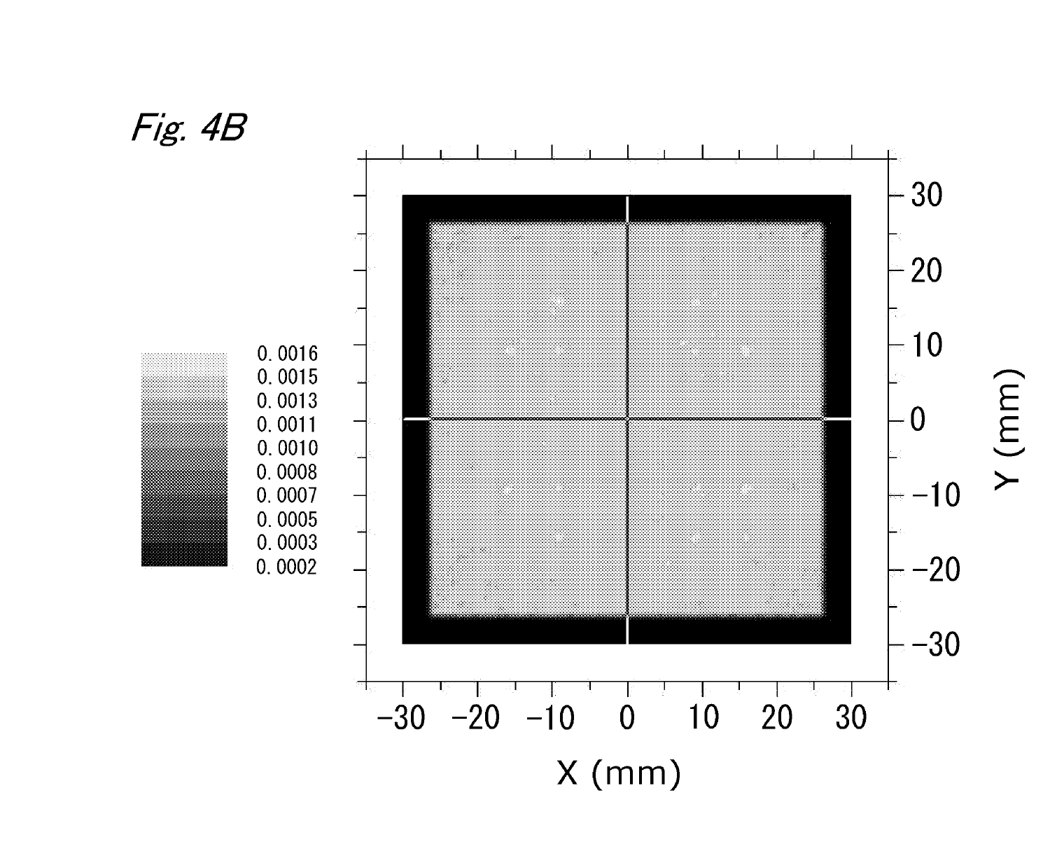

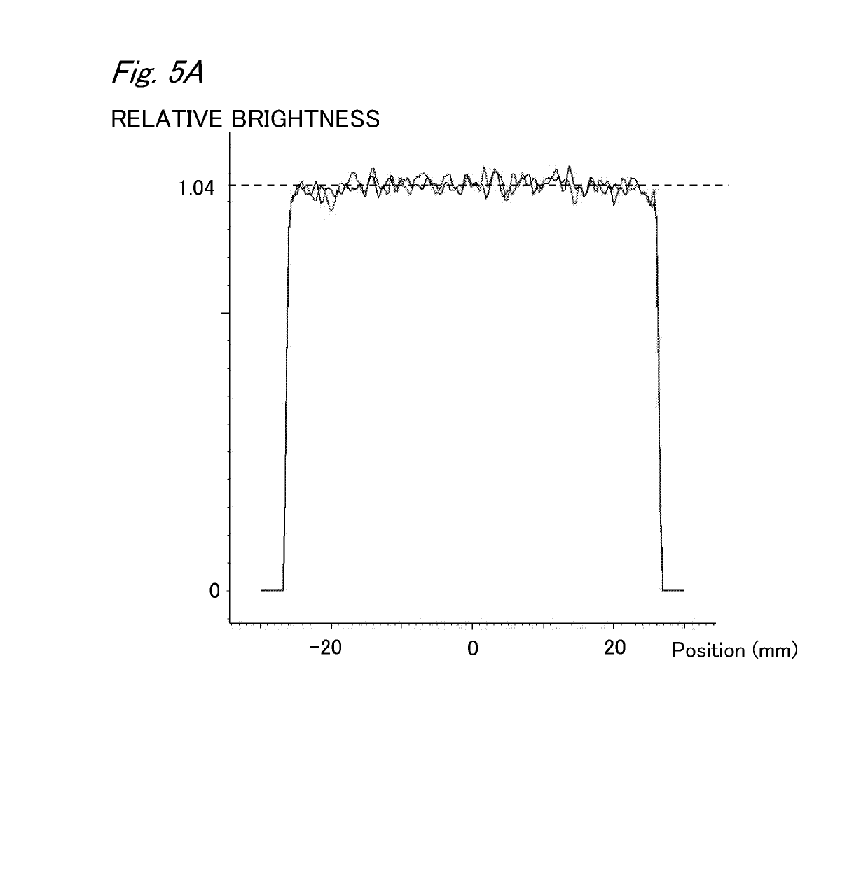

FIG. 4A is a diagram showing a brightness distribution on the evaluation surface (brightness distribution of light from the light source apparatus) that is obtained when the analytic model of the light source apparatus of the present embodiment is used. FIG. 4B is a diagram showing a brightness distribution on the evaluation surface that is obtained when the analytic model of the conventional light source apparatus is used. In each of the diagrams, X and Y represent a position of a horizontal direction and a position of a vertical direction, respectively.

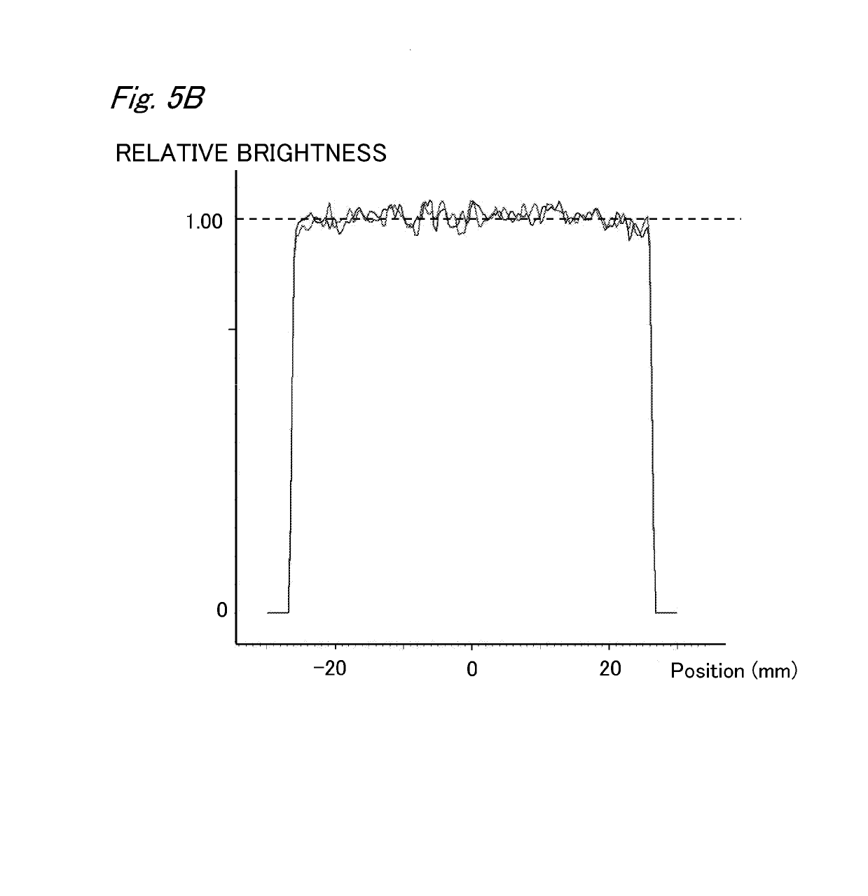

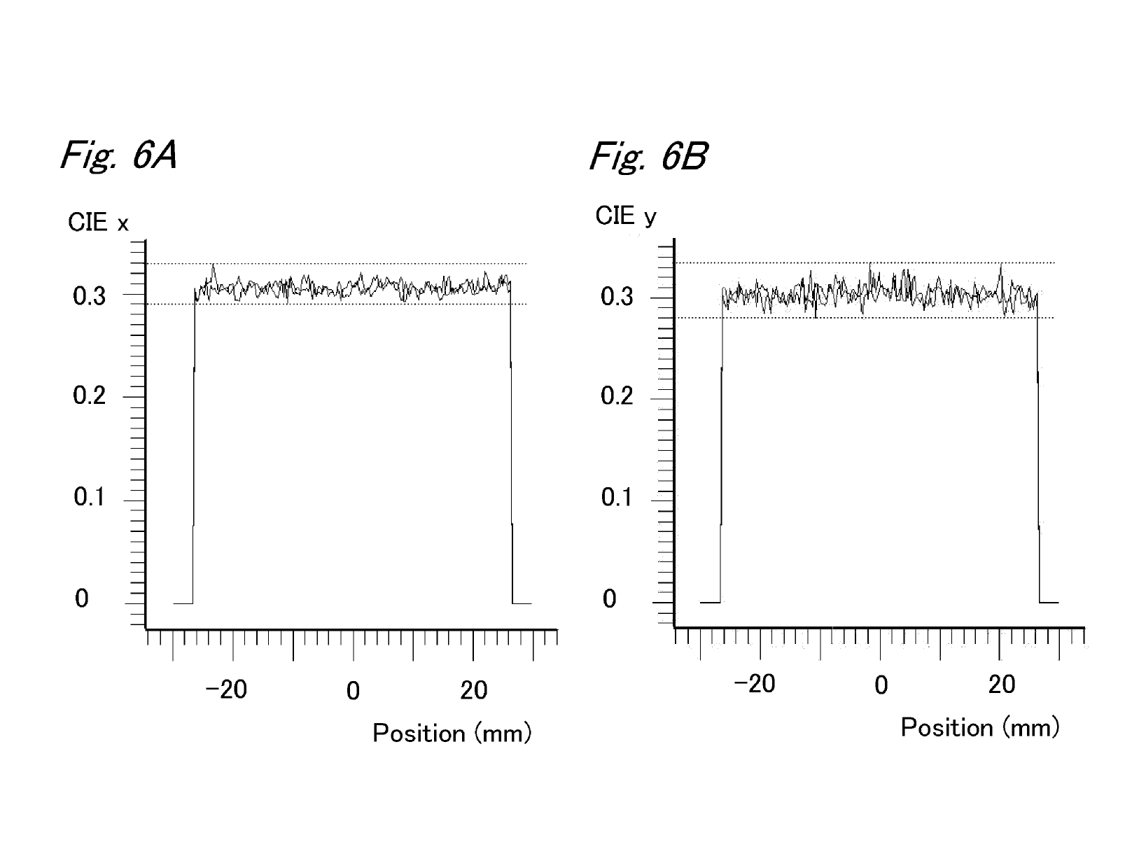

FIG. 5A is a diagram showing brightness obtained when X=0 in FIG. 4A and a brightness obtained when Y=0 in FIG. 4A. FIG. 5B is a diagram showing brightness obtained when X=0 in FIG. 4B and brightness obtained when Y=0 in FIG. 4B. The vertical axis of each of FIGS. 5A and 5B represents relative brightness with respect to average brightness of the conventional light source apparatus (average brightness obtained when X=0 in FIG. 4B or average brightness obtained when Y=0 in FIG. 4B). The horizontal axis of each of FIGS. 5A and 5B represents a position. Specifically, when observing the brightness of X=0, the horizontal axis of each of FIGS. 5A and 5B represents the position of Y. When observing the brightness of Y=0, the horizontal axis of each of FIGS. 5A and 5B represents the position of X.

It is clear from FIGS. 5A and 5B that the average brightness of the light source apparatus according to the present embodiment (average brightness when X=0 in FIG. 4A, average brightness when Y=0 in FIG. 4A) with respect to the average brightness of the conventional light source apparatus is approximately 1.04. In other words, the brightness of the light source apparatus according to the present embodiment improves by approximately 4%, compared to brightness obtained when causing the conventional light source apparatus to emit with the same power. Therefore, the light source apparatus of the present embodiment can lower the power consumption of the LEDs when obtaining the same level of brightness as the conventional light source apparatus. Lowering the power consumption can be expected to reduce the amount of heat generation of the LEDs and increase the operating life of the LEDs.

The results of examining variations in the chromaticity in the optical simulation are described hereinafter.

The distance (pitch P1) between the light-emitting centers of the adjacent LEDs shown in FIG. 1A is as follows:

P1=[{(b/2)+d+(a/2)}²+{(b/2)−(a/2)}²]^{(1/2)}≅6.7 (mm) (12)

where a=3 (mm), b=6 (mm), and d=2.0 (mm).

Furthermore,

tan θ={(b/2)−(a/2)}/{(b/2)+d+(a/2)}≅0.23 (13).

Therefore, θ≅13.0 degrees.

On the other hand, the distance (pitch P2) between the light-emitting centers of the adjacent LEDs in the conventional light source apparatus (FIG. 1B) is as follows:

P2=(b/2)+d+(a/2)=6.5 (mm) (14).

It is clear from Equations (12) and (14) that the distance between the light-emitting centers of the LEDs is greater in the light source apparatus of the present embodiment than in the conventional light source apparatus. More specifically, when a=3 (mm), b=6 (mm), and d=2.0 (mm), the distance between the light-emitting centers of the LEDs is greater in the light source apparatus of the present embodiment than in the conventional light source apparatus by P1−P2=0.2 (mm).

In addition, it is clear from Equation (13) that the square formed by connecting the light-emitting centers of the LEDs of the light source apparatus according to the present embodiment (the square of which length of each sides is P1) is inclined with respect to the square formed by connecting the light-emitting centers of the LEDs of the conventional light source apparatus (the square of which length of each sides is P2), by θ1. More specifically, when a=3 (mm), b=6 (mm), and d=2.0 (mm), the square formed by connecting the light-emitting centers of the LEDs of the light source apparatus according to the present embodiment is inclined with respect to the square formed by connecting the light-emitting centers of the LEDs of the conventional light source apparatus by 13.0 degrees.

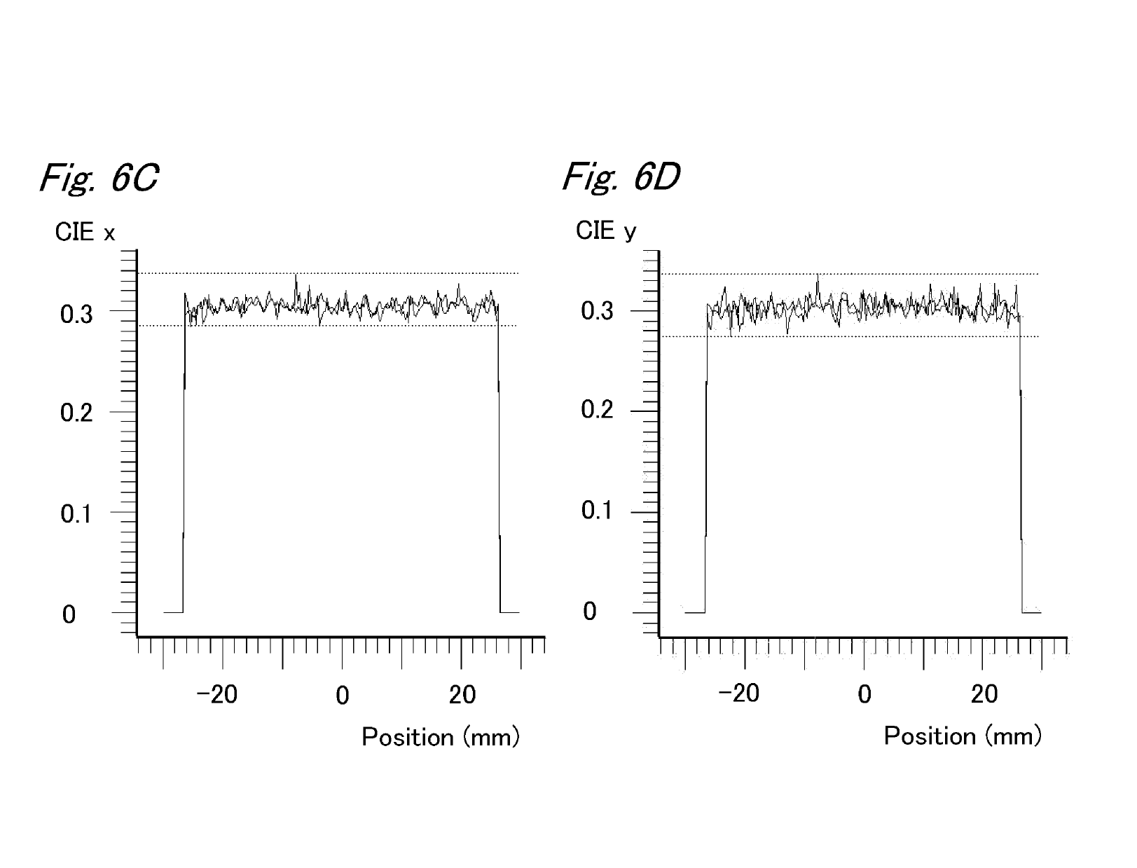

The results of examining variations in the chromaticity in a CIE display system are described hereinafter using FIGS. 6A to 6D. FIG. 6A shows a CIEx value obtained when X=0 in FIG. 4A and a CIEx value obtained when Y=0 in FIG. 4A. FIG. 6B shows a CIEy value obtained when X=0 in FIG. 4A and a CIEy value obtained when Y=0 in FIG. 4A. FIG. 6C shows a CIEx value obtained when X=0 in FIG. 4B and a CIEx value obtained when Y=0 in FIG. 4B. FIG. 6D shows a CIEy value obtained when X=0 in FIG. 4B and a CIEy value obtained when Y=0 in FIG. 4B.

As described above, the distance between the light-emitting centers of the LEDs is greater in the light source apparatus of the present embodiment than in the conventional light source apparatus by 0.2 (mm). However, when comparing FIGS. 6A and 6C, color variations in the configuration of the present embodiment is improved in the same manner as the conventional configuration. When also comparing FIGS. 6B and 6D, color variations in the configuration of the present embodiment is improved in the same manner as the conventional configuration. This is considered because the effective area on the reflective sheet of the configuration of the present embodiment is greater than that of the conventional configuration.

As described above, the configuration of the present embodiment can increase the reflective area (effective area) of the reflective sheet of the light source apparatus. As a result, the light emission brightness can be improved by effectively using the light from the LEDs. Additionally, the color variations of the light from the light source apparatus can be improved.

The light source apparatus according to the present embodiment can be applied to, for example, a backlight apparatus (a backlight apparatus provided on the back of a liquid crystal panel) for a liquid crystal display apparatus. The light source apparatus according to the present embodiment can be applied not only to a backlight apparatus but also to a lighting system, an advertisement display apparatus, an indicator, and the like.

Note that in the present embodiment a single light source group is configured by one red LED, one blue RED, and two green LEDs; however, the configuration of the light source groups is not limited thereto. For instance, a single light source group may be configured by one white LED, one red LED, one green LED, and one blue LED. Further, four LEDs configuring a single light source group may be of the same luminescent color. For instance, a single light source group may be configured by four white LEDs, four red LEDs, four green LEDs, or four blue LEDs.

Moreover, in the present embodiment a single through-hole exposes a single light source group; however, the configuration of the light source apparatus is not limited thereto. A single through-hole may expose a plurality of (two, for example) light source groups.

Note that the present embodiment has described an example in which the first LED is a red LED, the second and fourth LEDs are green LEDs, and the third LED is a blue LED; however, the first to fourth LEDs (first to fourth light-emitting members) are not limited to these colors. For example, the first LED may be a white LED, the second LED a red LED, the third LED a green LED, and the fourth LED a blue LED.

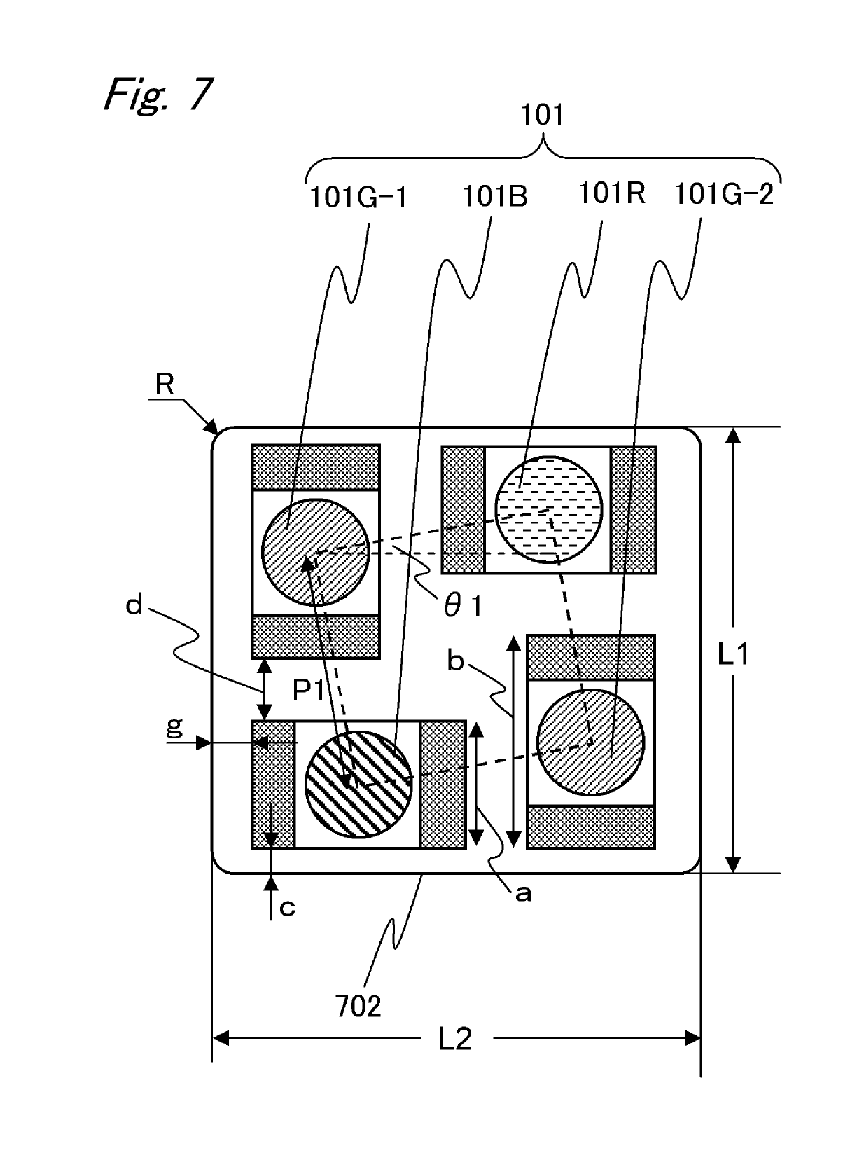

The present embodiment has described that the shape of the through-hole was a square (substantially square); however, the shape of the through-hole is not limited thereto. For example, the through-hole may have a rectangular (substantially rectangular) shape, as shown in FIG. 7. FIG. 7 is a diagram showing examples of the light source group and the through-hole of the light source apparatus according to the present embodiment. In the example shown in FIG. 7, the gap in a horizontal direction between a rim of a through-hole 702 and the longer side (shorter side) of each LED is represented as g (>c). The rest of the configuration is the same as the one shown in FIG. 1A. Therefore, in the configuration shown in FIG. 7, the through-hole 702 has a rectangular (substantially rectangular) shape.

In the configuration shown in FIG. 7 as well, when g=1.75 (mm), an effective area S3 of a reflective sheet thereof is as follows:

Effective area S3=50×50−{(13.0×14.5−(4−π))×4}≅1749 (mm²) (15),

(S3/S2)=(1749/1662)≅1.052 (16).

It is clear from these equations that the effective area of the reflective sheet of the configuration shown in FIG. 7 is greater than that of the conventional configuration (FIG. 1B) by approximately 5.2(%). As with the configuration shown in FIG. 1A, the configuration shown in FIG. 7 can also improve the light emission brightness and color variations of the light source apparatus.

### Other Embodiment

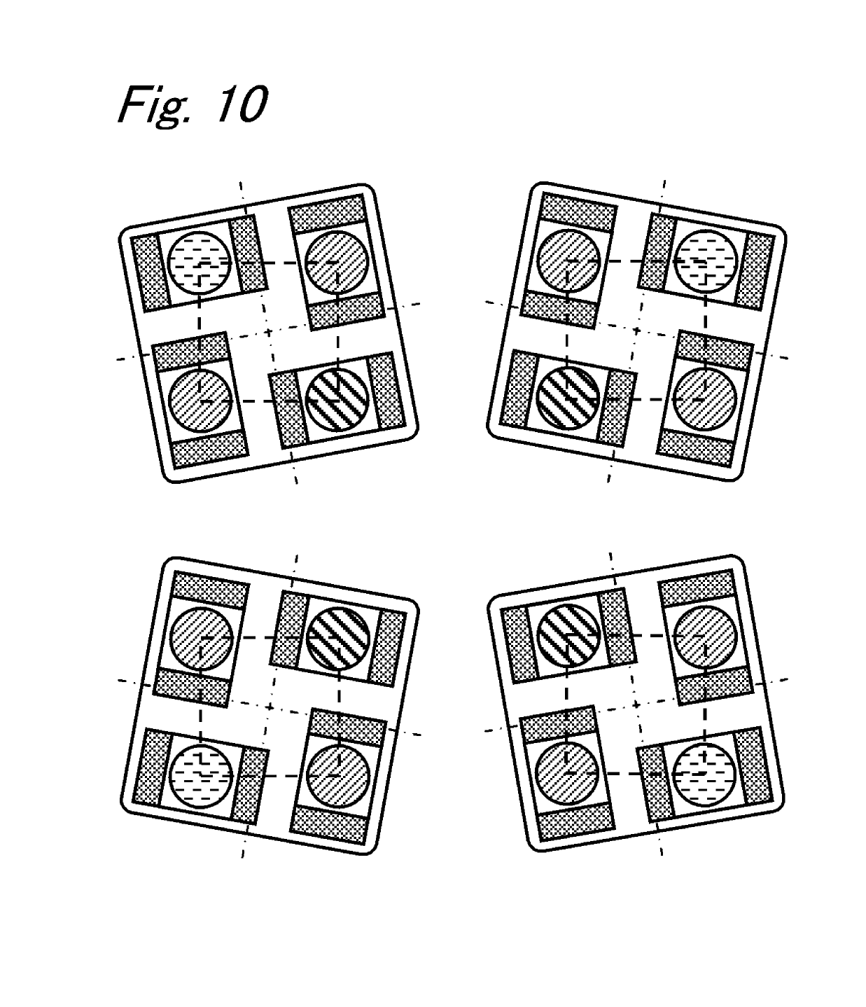

As shown in FIG. 10, the inclination angle of the square formed by connecting the light-emitting centers of the LEDs with respect to the square formed by connecting the light-emitting centers of the LEDs of the conventional configuration shown in FIG. 1B may be 0 degrees. The through-hole of each reflective sheet shown in FIG. 10 is inclined with respect to the through-hole of the reflective sheet shown in FIG. 1A according to the above-described embodiment by θ1. In this case as well, the same effects as those of the above-described embodiment can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-209575, filed on Sep. 26, 2011, and Japanese Patent Application No. 2012-149451, filed on Jul. 3, 2012, which are hereby incorporated by reference herein in their entirety.

What is claimed is:

1. A light source apparatus having a plurality of light-emitting members, comprising:
a light source substrate provided with a plurality of light source groups each of which is configured by first to fourth light-emitting members; and
a reflective sheet disposed on the light source substrate and having a hole exposing the light source group,
wherein, on a surface parallel to the light source substrate,
a circumscribed quadrangle of each of the first to fourth light-emitting members has a substantially rectangular shape, and
a shorter side of one of two adjacent light-emitting members is positioned on substantially the same straight line as a longer side of the other one of the two adjacent light-emitting members.

2. The light source apparatus according to claim 1,
wherein, on the surface parallel to the light source substrate,
a first shorter side of the first light-emitting member faces a first longer side of the second light-emitting member and a second shorter side of the first light-emitting member is positioned on substantially the same straight line as a second longer side of the fourth light-emitting member,
a first shorter side of the second light-emitting member faces a first longer side of the third light-emitting member and a second shorter side of the second light-emitting member is positioned on substantially the same straight line as a second longer side of the first light-emitting member,
a first shorter side of the third light-emitting member faces a first longer side of the fourth light-emitting member and a second shorter side of the third light-emitting member is positioned on substantially the same straight line as a second longer side of the second light-emitting member, and
a first shorter side of the fourth light-emitting member faces a first longer side of the first light-emitting member and a second shorter side of the fourth light-emitting member is positioned on substantially the same straight line as a second longer side of the third light-emitting member.

3. The light source apparatus according to claim 1,
wherein, on the surface parallel to the light source substrate,
a gap between the first light-emitting member and the second light-emitting member,
a gap between the second light-emitting member and the third light-emitting member,
a gap between the third light-emitting member and the fourth light-emitting member, and
a gap between the fourth light-emitting member and the first light-emitting member are substantially equal to one another.

4. The light source apparatus according to claim 1,
wherein on the surface parallel to the light source substrate,
a gap between a rim of the hole and the second longer side of each of the first to fourth light-emitting members is substantially equal to a gap between a rim of the hole and the second shorter side of each of the first to fourth light-emitting members.

5. The light source apparatus according to claim 1, wherein each of the first to fourth light-emitting members is configured by a light-emitting part and two electrode parts provided on either end of the light-emitting part.

6. The light source apparatus according to claim 1, wherein each of the first to fourth light-emitting members is configured by an LED (Light Emitting Diode).

7. The light source apparatus according to claim 6, wherein the LED includes at least a red LED, a green LED, a blue LED, or a white LED.

8. The light source apparatus according to claim 6, wherein each of the light source groups is configured by one red LED, two green LEDs, and one blue LED.

9. The light source apparatus according to claim 1, which is provided on a back of a liquid crystal panel.

10. A light source apparatus having a plurality of light-emitting members, comprising:
a light source substrate provided with a plurality of light source groups each of which is configured by first to fourth light-emitting members; and
a reflective sheet disposed on the light source substrate and having a hole exposing the light source group,
wherein, on a surface parallel to the light source substrate,
a circumscribed quadrangle of each of the first to fourth light-emitting members has a substantially rectangular shape,
a shorter side of one of two adjacent light-emitting members faces a longer side of the other one of the two adjacent light-emitting members, and
a shape of an outer circumference of each of the light source groups configured by the first to fourth light-emitting members is substantially a square.
